(19) United States
(12) Patent Application Publication
(10) Pub. No.: US 2001/0006444 A1
(43) Pub. Date: Jul. 5, 2001

(54) Magnetoresistive sensor

(76) Inventors: Jun Hayakawa, Kokubunji (JP); Hiroyuki Hoshiya, Odawara (JP); Kenichi Meguro, Matsuda (JP); katsuro Watanabe, Odawara (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/741,804

(22) Filed: Dec. 22, 2000

(30) Foreign Application Priority Data
Dec. 24, 1999 (JP) 11-366240

(51) Int. Cl. G11B 5/39

(52) U.S. Cl. 360/324.1

(57) ABSTRACT

A magnetic head having a spin-valve type giant magnetoresistive film in which a non-magnetic high conductive oxidized stopper layer and an oxide protective layer with favorable magnetic characteristic for attaining high output, as well as a magnetic recording apparatus are provided, in which an additional non-magnetic high conductance oxidized stopper layer and an oxide film protective layer are laminated successively on the side of the surface adjacent to the soft magnetic free layer thereby increasing the giant magnetoresistive effect more than existent spin valve to prepare a high power magnetic head.

### BACKGROUND OF THE INVENTION

1. Field of the Invention

This invention concerns a magnetoresistive element for reproducing magnetically recorded information and, more in particular, it relates to a magnetic reading/writing apparatus at high density using the magnetoresistive element for a reproducing head.

2. Related Prior Art

Japanese Published Unexamined Patent Application No. Hei 4-358310 discloses a structure referred to as a spin-valve structure as one of heads using a giant magnetoresistive (GMR) effect.

Japanese Published Unexamined Patent Application No. Hei 6-236527 describes a spin-valve type magnetoresistive sensor in which a back layer comprising a non-magnetic conductive material is disposed adjacent to a ferromagnetic layer.

Physical Review Letters, vol. 75 (1995), pp 4306-4309 describes the dependence of the interlayer coupling field on the thickness of the Cu back layer in a Co/Cu/Co three layered film.

Journal of Applied Physics, vol. 85 (1997), pp 6142-6152 describes increase for the giant magnetoresistive effect using an oxidized surface film.

In the prior art for increasing the recording density in recording apparatus in recent years, it has been impossible to obtain magnetic recording apparatus having a sufficiently high recording density and, particularly, a magnetoresistive element in the reproducing portion thereof that operates at a sufficient sensitivity and output to the external magnetic field and, further, obtain favorable characteristic with sufficiently controlled stability for the output and it has been difficult to realize the function as the recording apparatus. Therefore, it has been demanded for improving the performance of the magnetic head.

A structure referred to as a spin valve which is a giant magnetoresistive effect element has been proposed for the reproducing portion of magnetic heads. The spin valve has a structure of ferromagnetic layer/non-magnetic intermediate layer/soft magnetic layer in which the magnetization of the ferromagnetic layer is substantially fixed within a range of a magnetic field to be sensed by magnetic coupling with the anti-ferromagnetic layer adjacent thereto. Rotation of the magnetization of the soft magnetic layer relative to the external magnetic field produces change of electric resistance to obtain an output corresponding to the relative angle of magnetization between the ferromagnetic layer and the soft magnetic layer. The magnetic field showing the magnitude of the magnetic coupling between the ferromagnetic layer and the soft magnetic layer is referred to as the interlayer coupling field. Further, the method of fixing the magnetization for the ferromagnetic layer is referred to as a pinning bias method, the anti-ferromagnetic film is referred to as a pinned bias film and the ferromagnetic layer pinned for the magnetization is referred to as a ferromagnetic pinned layer. In the same manner, the soft magnetic layer is referred to as a soft magnetic free layer.

On.the other hand, as a means for improving the change of electric resistivity (ΔR) of the spin valve film, utilization of an oxidized surface film has been studied in recent years. This is a means of disposing an oxide film on the surface of the spin valve film to increase ΔR. However, when the oxide film is disposed on the surface, oxygen diffuses from the oxide film to the magnetic layer to bring about problems such that the magnetic layer is oxidized to deteriorate the magnetic characteristic or stresses caused by oxide in the oxide film propagate to the magnetic layer to deteriorate the magnetic characteristic.

### SUMMARY OF THE INVENTION

This invention aims at solving the foregoing problem and provides a spin-valve type magnetoresistive effect film, as well as a magnetic head, capable of obtaining higher output than the existent structure. Further, it intends to provide a magnetic recording apparatus using the magnetic head described above.

For attaining high density recording, a magnetic recording apparatus mounting, on a magnetic head, a magnetic sensor using a giant magnetoresistive film is used in this invention as means for attaining the high density recording. As the magnetic sensor, a spin-valve type giant magnetic resistive film comprising an anti-ferromagnetic film/ferromagnetic pinned layer/non-magnetic conductive layer/soft magnetic free layer/non-magnetic high conductance oxidized stopper layer/oxide protective layer is used as the magnetic sensor.

There are three ways of solving the subject in this invention. At first, oxide protective film is disposed on the soft magnetic free layer in order to improve ΔR. As the material for the oxide protective film, oxide such as of Ta, Ni, Nb, Ti, Hf and W can be used, Ta oxide being preferred with a view point of improving ΔR.

Secondly, a high conductance oxidized stopper layer is disposed between the oxide protective layer and the soft magnetic free layer. The non-magnetic high conductance oxidized stopper layer prevents diffusion of oxygen from the oxide protective layer or propagation of stresses caused by oxides as far as the soft magnetic free layer and prevents degradation of the soft magnetic characteristic of the free layer. This can prevent lowering of the sensitivity of the spin valve film and, further, prevent lowering of the output. Further, disposition of the conductive layer causes elastic scattering of itinerane electrons at the boundary between the non-magnetic high conductance oxidized stopper layer and the oxide protective film to extend the mean free stroke length of itinerane electron to improve ΔR more than the existent spin valve structure. As the material for the non-magnetic high conductance oxidized stopper layer, Cu, Pd, Pt, Os, Rh, Re, Ru, Ag and Au are generally used but the materials are not restricted to the foregoings so long as they are non-magnetic and conductive.

Thirdly, the thickness of the non-magnetic high conductance oxidized stopper layer is selected such that the interlayer coupling field is reduced to zero. Since the sensitivity of the spin valve film is lowered as the interlayer coupling field increases, the interlayer coupling field is desirably lower. When the non-magnetic high conductance oxidized stopper layer is disposed, the thickness of the non-magnetic high conductance oxidized stopper layer can be selected such that the interlayer coupling field is substantially reduced to zero since the interlayer coupling field changes along with the thickness of the conductive layer. This can prevent lowering of the sensitivity caused by increase in the interlayer coupling field.

According to this invention, a spin-valve type magnetic head more excellent in the sensitivity and capable of obtaining higher output than existent structure can be provided by introducing the oxide protective layer and the high conductance oxidized stopper layer to the spin-valve film. Further, magnetic reading/writing apparatus having favorable writing output and stability at high recording density can be obtained by using the magnetic head according to this invention.

### BRIEF DESCRIPTION OF THE DRAWINGS

Other objects and advantages of the invention will become apparent during the following discussion of the accompanying drawings, wherein:

FIG. 1 is a view illustrating a first constitutional example of a magnetoresistive lamination film of a magnetic head according to this invention;

FIG. 2 is a view illustrating a second constitutional example of a magnetoresistive lamination film of a magnetic head according to this invention;

FIG. 3 is a view illustrating a constitutional example of a magnetoresistive lamination film of a magnetic head not having a high conductance oxidized stopper layer;

FIG. 4 is a view illustrating a constitutional example of a magnetoresistive lamination film of a magnetic head not having an oxide protective layer;

FIG. 5 is a view illustrating a third constitutional example of a magnetoresistive lamination film of a magnetic head according to this invention;

FIG. 6 is a view illustrating a fourth constitutional example of a magnetoresistive lamination film of a magnetic head according to this invention;

FIG. 7A is a graph showing a magnetoresistive curve (major loop) of a magnetic head according to this invention and a magnetic head in which the oxide protective layer is not oxidized;

FIG. 7B is a graph showing a magnetoresistive curve (major loop) of a magnetic head according to this invention and a magnetic head not having an oxide protective layer;

FIG. 8A is a graph showing a magnetoresistive curve (minor loop) of a magnetic head according to this invention and a magnetic head in which the oxide protective layer is not oxidized;

FIG. 8B is a graph showing a magnetoresistive curve (minor loop) of a magnetic head according to this invention and a magnetic head not having an oxide protective layer;

FIG. 9 is a graph illustrating the dependence of change of resistance (ΔR) of a magnetic head according to this invention on the thickness of NiFe film;

FIG. 10 is a graph illustrating the dependence of change of resistance (ΔR) of a magnetic head according to this invention on the thickness of an oxide protective layer;

FIG. 11 is a graph illustrating the dependence of change of resistance (ΔR) of a magnetic head according to this invention on the thickness of a non-magnetic oxide high conductance oxidized stopper layer;

FIG. 12 is a graph illustrating the dependence of an interlayer coupling field of a magnetic head according to this invention on the thickness of a non-magnetic high conductance oxidized stopper layer;

FIG. 13 is a schematic view illustrating a structure of reading/writing separation head having a magnetic head mounted thereon according to this invention;

FIG. 14 is a schematic view illustrating a state that the magnetic reading/writing apparatus having the magnetic head according to this invention mounted thereon actually conducts reading/writing; and

FIG. 15 is a schematic view illustrating a constitution of a magnetic reading/writing apparatus having a magnetic head according to this invention mounted thereon.

### DETAILED DESCRIPTION OF THE INVENTION

All magnetic heads in the examples described below were prepared using a DC magnetron sputtering apparatus in an Ar 3 mm Torr atmosphere by successively laminating the following materials on a glass substrate of 1 mm thickness and 3 inch diameter. As sputtering targets, 46 at % Pt-54 at % Mn, CoFe, Cu, NiFe and Ta disposed with an Mn chip were used. Further, the composition was controlled by disposing Ni chip on the NiFe target.

For preparing the lamination film, DC power was applied to each of cathodes on which each target was disposed to generate plasma in the apparatus and each of the layers was formed successively by opening/closing the shutters disposed on every cathodes one by one. A magnetic field at about 80 Oe was applied in parallel with the substrate by using a permanent magnet upon formation of the films to induce uniaxial magnetic anisotropy. The oxide protective film was formed by exposing the surface of the Ta layer to an oxygen containing atmosphere. The element was formed on the substrate by patterning in a photo-resist step. Subsequently, the substrate was fabricated into a slider and mounted to a magnetic recording apparatus.

The interlayer coupling field can be determined based on a minor loop for the magnetoresistive curve. A mean value of the magnetic field such that the magnitude of the magnetic resistance is one-half of the difference between the maximum value and the minimum value is a magnitude for the interlayer coupling field. The minor loop of the magnetic resistance curve was measured by a four terminal method by using a commercially available magnetoresistive effect measuring apparatus by applying an external field in a state of supplying DC current to the magnetoresistive film and sweeping the magnitude from −50 Oe to 50 Oe.

Example 1

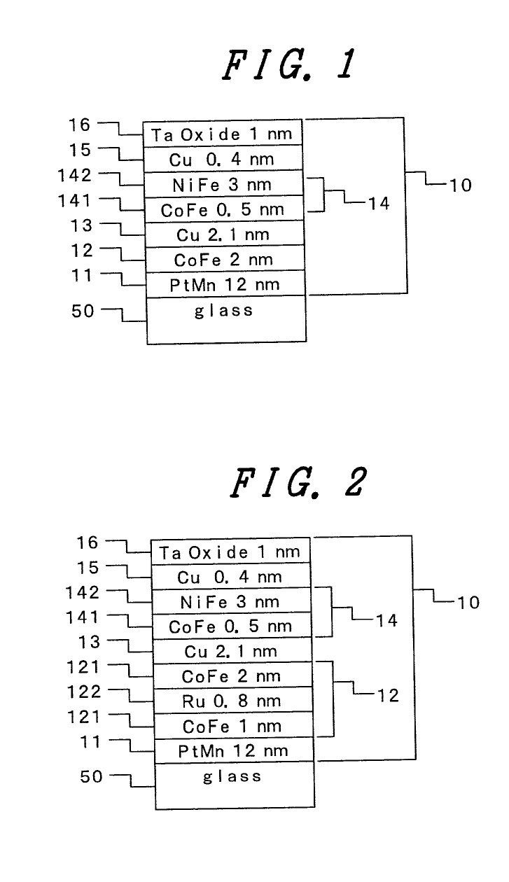

FIG. 1 illustrates an example of applying this invention to a spin valve type magnetic head. A magnetoresistive lamination film 10 comprises an anti-ferromagnetic film 11, a ferromagnetic pinned layer 12, a non-magnetic intermediate layer 13, a soft magnetic free layer 14 and a non-magnetic high conductance oxidized stopper layer 15, and an oxide protective layer 16 laminated in this order on a glass substrate 50 (indicated as “glass” in the drawing). The soft magnetic free layer 14 comprises a Co based alloy film 141 and an Ni based alloy film 142.

The oxide protective layer 16 is substantially oxidized entirely by a step exposed to an oxygen-containing atmosphere. The non-magnetic high conductance oxidized stopper layer 15 has a function of preventing the diffusion of oxygen from the oxide protective film or propagation of stresses due to oxides in the protection film to the soft magnetic free layer 14, and preventing degradation of the soft magnetic characteristic of the soft magnetic free layer.

As a Comparative Example 1, a spin valve type magnetic head of a structure not having the high conductance oxidized stopper layer was manufactured. FIG. 3 shows a lamination structure thereof. The structure of the magnetoresistive film is identical with that in FIG. 1 except for not having the high conductance oxidized stopper layer.

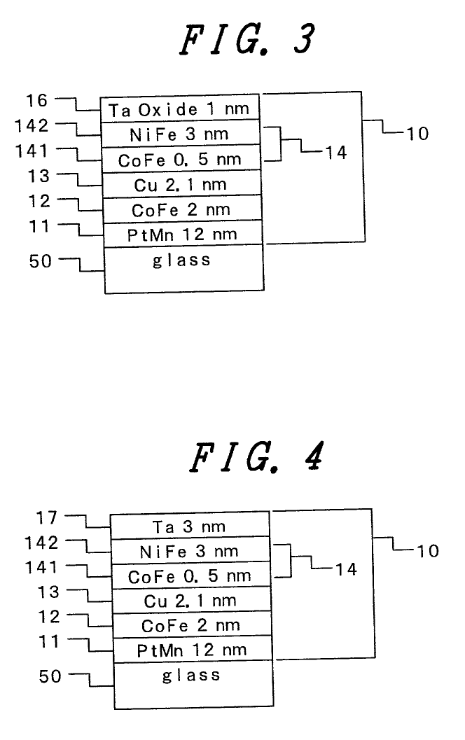

As a Comparative Example 2, a spin valve type magnetic head of a structure in which the oxide protective layer is not oxidized and not having the high conductance oxidized stopper layer was also manufactured as a Comparative Example 1. FIG. 4 shows a.lamination structure thereof. While the preparation procedures are identical with those for the magnetic head shown in FIG. 1 to FIG. 3, excepting for not by way of a step of exposing the surface to an oxygen-containing atmosphere. The thickness for the Ta layer is as large as 3 nm in order to prevent auto-oxidation due to aerial oxygen from progressing as far as the boundary between the Ta layer and the NiFe layer.

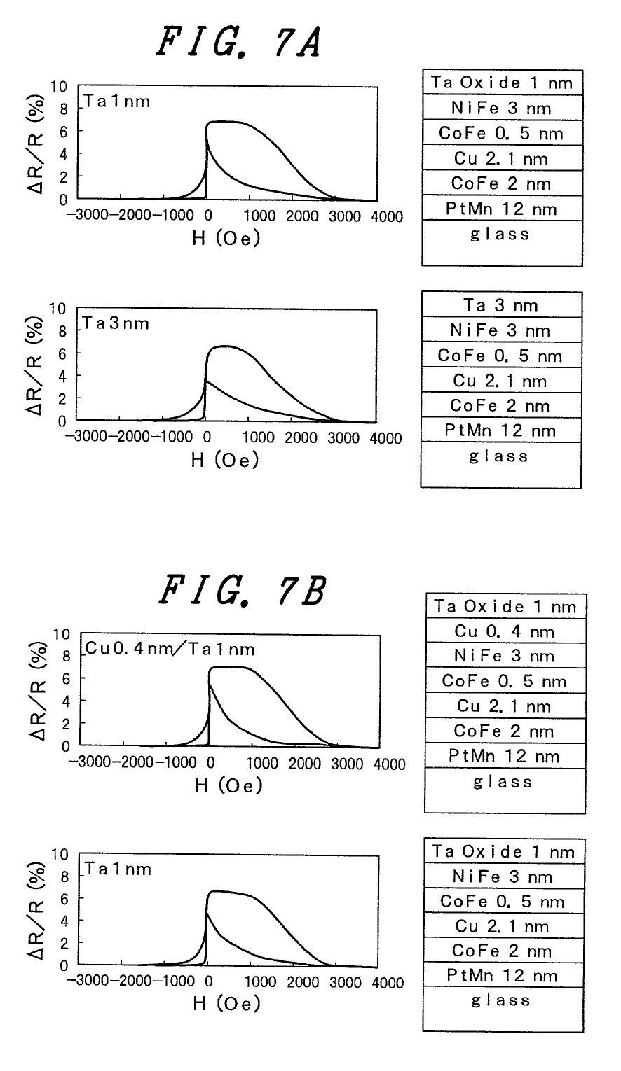

FIG. 7A illustrates the magnetoresistive curves for the magnetic head in FIG. 3 and the magnetic head in FIG. 4 in comparison for illustrating the effect of the oxide protective layer. In FIG. 7A, the upper curve shows the magnetoresistive curve for the magnetic head in FIG. 3 and the lower curve shows the magnetoresistive curve for the magnetic head in FIG. 4 respectively. The maximum value for the magnetic resistance ratio (ΔR/R) is increased by about 0.5% in the magnetic head in which the protective film is oxidized compared with the magnetic head in which the protective film is not oxidized.

FIG. 7B illustrates the magnetoresistive curves for the magnetic head in FIG. 1 and the magnetic head in FIG. 3 in comparison for illustrating the effect of the high conductance oxidized stopper layer. In FIG. 7B, the upper curve shows the magnetoresistive curve for the magnetic head in FIG. 1 and the lower curve shows the magnetoresistive curve for the magnetic head in FIG. 3 respectively. It can be confirmed that the maximum value for (ΔR/R) is increased by about 1.0% in the magnetic head having the high conductance oxidized stopper layer compared with the magnetic head not having the stopper layer.

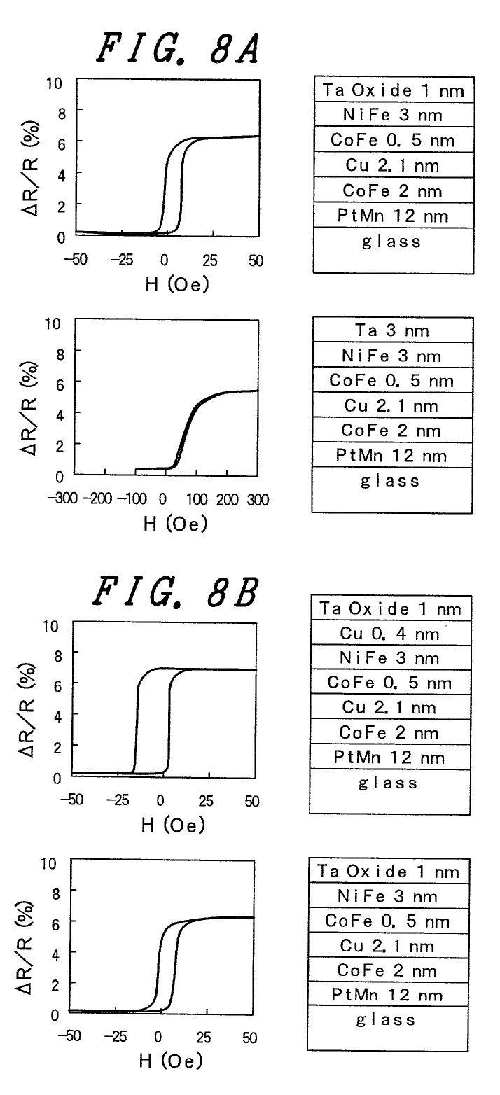

FIG. 8A shows minor loops illustrating the magnetic characteristics of the soft magnetic free layers for the two spin valve type magnetic heads illustrated in FIG. 7A in comparison.

The upper curve in FIG. 8A illustrates a magnetoresistive curve for the first magnetic head shown in FIG. 1, and the lower graph in FIG. 8A illustrates a magnetoresistive curve for the magnetic head shown in FIG. 4 respectively. A magnetic head in which the protective film is oxidized has a larger squareness ratio compared with the magnetic head in which the protective film is not oxidized. Since ΔR/R is improved as the squareness ratio is larger, a larger squareness ratio is more preferred.

FIG. 8B illustrates minor loops showing the magnetic characteristics of the soft magnetic free layers of two spindle valve type magnetic heads shown in FIG. 7B in comparison. In FIG. 8B, the upper curve shows a magnetoresistive curve for the magnetic head shown in FIG. 1 while the lower curve in FIG. 8B shows a magnetoresistive curve for the magnetic head in FIG. 3 respectively. The minor loop of the magnetic head having the high conductance oxidized stopper layer has greater squareness ratio compared with the minor loop for the magnetic head not having the stopper layer.

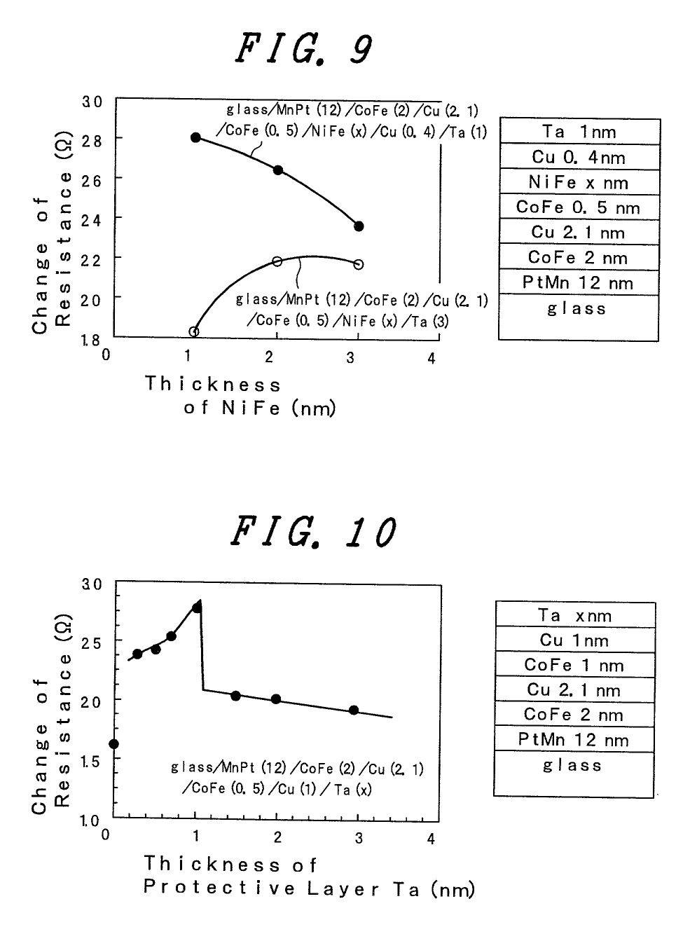

FIG. 9 is a graph illustrating a relationship between the thickness of the NiFe film and the change of resistance (ΔR) in a case where the thickness of the NiFe film of the free layer is changed from 1 nm to 3 nm in a magnetic head shown in FIG. 1 having an oxide protective layer and an a high conductance oxidized stopper layer and a magnetic head shown in FIG. 4 in which the protective film is not oxidized and not having the high conductance oxidized stopper layer. In any of the thickness of the NiFe film, the magnetic head having the oxide protective layer and the high conductance oxidized stopper layer shows larger ΔR than the magnetic head in which the protection film is not oxidized and not having the high conductance oxidized stopper layer.

As described above, provision of the oxide layer protective film, ΔR, ΔR/R and squareness ratio of the spin valve film are improved and, by the provision of the high conductance oxidized stopper layer in addition to the oxide protective film can further improve ΔR, ΔR/R and squareness ratio.

FIG. 10 shows a relation between ΔR and Ta film thickness of a spindle valve type magnetic head according to this invention in which the thickness of the Ta film as the oxide protective layer is changed. The film structure is glass/MnPt/CoFe/Cu/CoFe/Cu/Ta. It can be confirmed that a particularly large AR can be obtained when the Ta film thickness is 1.0 nm or less.

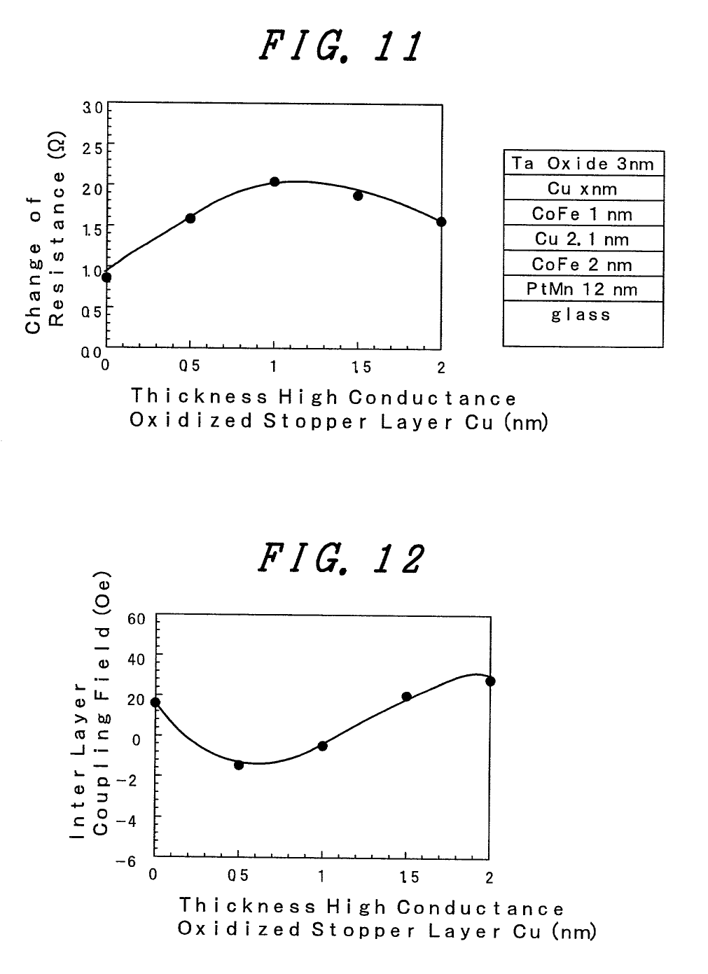

FIG. 11 shows a relationship between the change of resistance (ΔR) and the Cu film thickness in the spin valve type magnetic head according to this invention in a case where the thickness of the Cu film as the high conductance oxidized stopper layer is changed. The film structure is glass/MnPt/CoFe/Cu/CoFe/NiFe/Cu/Ta, but the Ta layer is not oxidized. This is for confirming the effect only of the change of the film thickness for the high conductance oxidized stopper layer while excluding the effect by the oxide protective film. ΔR increases along with increases in the thickness of Cu film, reaches a maximum value at the Cu thickness of 1.0 nm and decreases as the film thickness further increases. This because the interlayer coupling field changes with the thickness of the Cu film and accompanying therewith, the sensitivity of the spin valve film is changed.

For showing the foregoings, FIG. 12 shows the dependence of the interlayer coupling field on the thickness of the high conductance oxidized stopper layer. The film structure of the magnetic head is identical with the head shown in FIG. 11. The magnitude of the interlayer coupling field is substantially reduced to zero near the film thickness of 1.0 nm at which the change of resistance reaches maximum in FIG. 11. As described above, by properly selecting the thickness of the high conductance oxidized stopper layer it is possible to suppress the magnitude of the interlayer coupling field substantially to zero and can prevent the degradation of the sensitivity of the spin valve film.

Example 2

FIG. 2 illustrates an example of applying this invention to a spin valve type magnetoresistive film of another structure. The magnetoresistive lamination film 10 comprises an anti-ferromagnetic film 11, a ferromagnetic pinned layer 12, a non-magnetic intermediate layer 13, a soft magnetic free layer 14, a non-magnetic high conductance oxidized stopper layer 15, and an oxide protective film 16 laminated on a substrate 50. The ferromagnetic pinned layer 12 in FIG. 2 has a structure in which ferromagnetic Co based alloy film 121, Ru film 122 and Co based alloy film 123 are laminated, which is referred to as a synthetic ferri-lamination film. The Ru film 122, has a function of arranging magnetization of the Co based alloy film 121 and the Co based alloy film 123 in an anti-parallel alignment and the ferromagnetic pinned layer 12 can be provided entirely with magnetization by changing the film thickness of the Cu based alloy 121 and 123 as the ferromagnetic layer thereof. The soft magnetic free layer 14 comprises a Co based alloy film 141 and an Ni based alloy film 142. By the provision of the oxide protective layer and the high conductance oxidized stopper layer, ΔR, ΔR/R and squareness ratio are improved.

Example 3

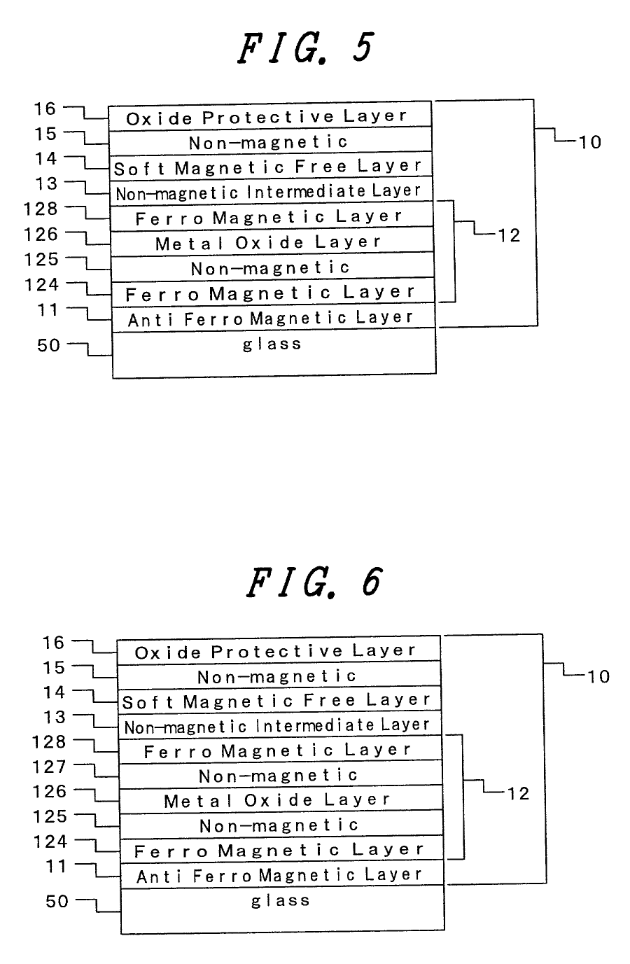

FIG. 5 illustrates an example of applying this invention to a spin-valve type magnetic head of another structure. The magnetoresistive lamination film 10 comprises a basic structure of laminating an anti-ferromagnetic film 11, a ferromagnetic pinned layer 12, a non-magnetic intermediate layer 13 and a soft magnetic free layer 14 laminated on a substrate 50 in which the ferromagnetic pinned layer 12 comprises a ferromagnetic layer 124, a non-magnetic high conductance oxidized stopper layer 125, a metal oxide layer 126 and a ferromagnetic layer 128. The metal oxide layer 126 of the ferromagnetic pinned layer is substantially oxidized entirely by the step exposed to the oxygen-containing atmosphere. In the same manner as in Example 3, by the provision of the oxide layer protective layer and the high conductance oxidized stopper layer, ΔR, ΔR/R and squareness ratio are improved.

Example 4

FIG. 6 illustrates an example of applying this invention to a spin-valve type magnetic head of a further different structure. The magnetoresistive lamination film 10 comprises a basic structure of laminating an anti-magnetic film 11, a ferromagnetic pinned layer 12, a non-magnetic intermediate layer 13 and a soft magnetic free layer 14 on a substrate 50, in which the ferromagnetic pinned layer 12 comprises a ferromagnetic layer 124, a non-magnetic high conductance oxidized stopper layer 125, a metal oxide layer 126, a non-magnetic high conductance oxidized stopper layer 127 and a ferromagnetic layer 128. The metal oxide layer 126 in FIG. 6 is entirely oxidized substantially by a step exposed to an oxygen-containing atmosphere in the same manner as in FIG. 5. By the provision of the oxide layer protective layer and the high conductance oxidized stopper layer, ΔR, ΔR/R and squareness ratio are improved.

Example 5

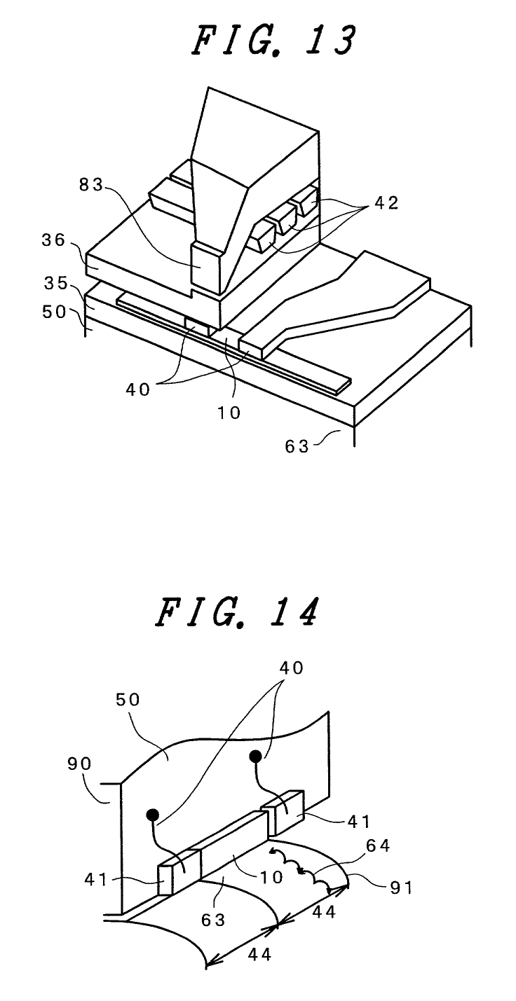

FIG. 13 is a conceptional view illustrating the structure of a reading/writing separation type magnetic head having a spin-valve type magnetic head according to this invention mounted thereon.

A magnetoresistive lamination film 10, an electrode 40, a lower shield 35, an upper shield and lower core 36, a writing gap 37, coils 42, and upper core 83 are formed on a substrate 50, and an opposing surface 63 is formed.

FIG. 14 is a schematic view illustrating a state that the magnetic reading/writing apparatus a magnetic head according to this invention mounted thereon actually conducts reading/writing. A magnetoresistive lamination film 10, a magnetic domain control film 41 and an electrode 40 are formed on a substrate 50 that also serves as a head slider 90, and the magnetic head comprising them is positioned on a recording track 44 of a recording medium 91 to conduct writing. The head slider 90 conducts relative movement with an opposing surface 63 being opposed on the recording medium 91 at a flying height of 0.1 mm or less or in contact therewith. In this mechanism, the magnetoresistive lamination film 10 reads magnetic signals recorded on the magnetic recording medium 91 from the leaked field 64 of the magnetic recording medium 91.

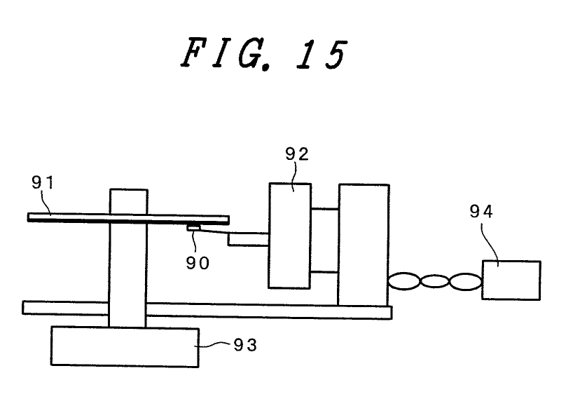

FIG. 15 is a schematic view illustrating a constitution of a magnetic reading/writing apparatus according to this invention. A recording medium 91 for magnetically recording information is rotated by a spindle motor 93 and a head slider 90 is guided by an actuator 92 on the track of the recording medium 91. That is, in the magnetic disk apparatus, the reproducing head and the recording head formed on the head slider 90 conducts relative movement by the mechanism in the vicinity of a predetermined recording position on the recording medium 91, and write and read signals successively. The actuator 92 is preferably a rotary actuator. Recording signals are recorded through a signal processing system 94 by the recording head on the medium and the output from the reproducing head is obtained by way of the signal processing system 94 to obtain signals. Further, when the reproducing head is moved onto a desired recording track, the position on the track is detected by using an output at high sensitivity from the reproducing head and the actuator can be controlled to conduct positioning of the head slider. While the head slider 90 and the recording medium 91 are illustrated each by one in this drawing, they may be disposed in plurality. Further, in the recording medium 91, information may be recorded on both surfaces of the medium. When the information is recorded on both surfaces of the disk, the head slider 90 is disposed on both surfaces of the disk.

When the magnetic head according to this invention shown in FIG. 1 and a magnetic head shown in FIG. 4, in which the oxide forming protective layer is not oxidized and not having high conductance oxidized stopper layer were assembled into the magnetic recording apparatus shown in FIG. 15 and the reproduced outputs were compared, the ratio of the change of resistance (ΔR/R) was 6% in the magnetic recording apparatus using the magnetic head in which the oxide protective layer is not oxidized and not having high conductance oxidized stopper layer, whereas ΔR/R in the magnetic recording apparatus using the magnetic head according to this invention was 8% and improvement in the output by 2% was confirmed.

While the invention has been particularly shown and described with reference to preferred embodiments thereof, it will be understood by those skilled in the art that the foregoing and other changes in form and details can be made therein without departing from the spirit and scope of the invention.

What is claimed is:

1. A magnetic head having a magnetoresistive film comprising an anti-ferromagnetic layer, a ferromagnetic -pinned layer, a non-magnetic intermediate layer, a soft magnetic free layer and an oxide layer of metal selected from Ta, Nb, Ti, Hf, W or an alloy thereof laminated in this order on a substrate.

2. A magnetic head as defined in claim 1, wherein the anti-ferromagnetic layer, the ferromagnetic pinned layer, the non-magnetic intermediate layer, and a non-magnetic and conductive film between the soft magnetic free layer and the oxide layer are laminated in this order on a substrate.

3. A magnetic head as defined in claim 1, wherein the thickness of the metal oxide layer is 1.0 nm or less.

4. A magnetic head as defined in claim 1, wherein the interlayer coupling field showing the magnitude of the ferromagnetic coupling between the ferromagnetic pinned layer and the soft magnetic free layer is substantially zero.

5. A magnetic head as defined in claim 2, wherein the thickness of the metal oxide layer is 1.0 nm or less.

6. A magnetic head as defined in claim 5, wherein the interlayer coupling field showing the magnitude of the ferromagnetic coupling between the ferromagnetic pinned layer and the soft magnetic free layer is substantially zero.

7. A magnetic head as defined in claim 4, wherein the thickness of the metal oxide layer is 1.0 nm or less.

8. A magnetic recording apparatus including a magnetic recording medium for recording information, a magnetic head having a magnetoresistive film comprising an anti-ferromagnetic layer, a ferromagnetic pinned layer, a non-magnetic intermediate layer, a soft magnetic free layer, a non-magnetic and conductive film, and an oxide layer of metal selected from Ta, Nb, Ti, Hf, W or an alloy thereof laminated in this order on a substrate, a head slider for holding the magnetic head, an actuator for guiding the head slider to a predetermined recording position of the recording position on the recording medium, a spindle motor rotating the recording medium and a signal processing system for processing information read out of the magnetic recording medium.
